(19) United States
(12) Patent Application Publication
(10) Pub. No.: US 2004/0102104 A1
(43) Pub. Date: May 27, 2004

(54) Electric connector

(76) Inventors: Keiji Kuroda, Amagasaki-shi (JP); Kiyoshi Aramoto, Osaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/676,024

(22) Filed: Oct. 2, 2003

(30) Foreign Application Priority Data
Oct. 21, 2002 (JP) JP2002-305307

(51) Int. Cl. H01R 13/432

(52) U.S. Cl. 439/748

(57) ABSTRACT

An electric connector is composed of a female connector (1) with an insulated housing (2) and a male connector (21) with a housing (22) having a cavity (23). The housing (2) has compartments (3) to discretely hold socket contacts (42) each lying on its side and secured on a wire end (41). A lance (43) of each socket contact faces sideways so as to be latched by a lug (4) formed in and protruding from an inner wall surface of each compartment (3). Characteristically, peep holes (16,17) are formed in the upper wall (14) or lower wall (15) of the female housing (2), such that the lugs (4) are exposed to the outside. The male housing (22) will cover and hide the peep holes when the female housing is inserted into the cavity (23). The lance of each socket contact can visually be checked to confirm its exact engagement with the lug, ensuring exact mutual connection of the female and male connectors, rendering the electric connector as a whole reliable in performance, nevertheless making it compacted and resistant to high voltages.

### FIELD OF THE INVENTION

The present invention relates to an electric connector provided as a pair of male and female connectors fitting one in another, and more particularly, it relates to an electric connector composed of a socket connector and a base connector detachably fitting thereon and surface-mounted on a printed circuit board, the socket connector having a plurality of socket contacts fixed therein and secured on electric wire ends, wherein the electric connector is of a depressed shape and adapted for use under high voltages.

### PRIOR ART

Some electric connectors of this type are known in the art (see for example, Japanese Patent Laying-Open Gazette No. 10-125384, paragraph 0015, and FIG. 1, and Japanese Patent Publication No. 3254188, page 2, column 4, and FIG. 7). Each of these prior art connector comprises a female connector of a depressed shape and a male connector having a cavity with a front opening for reception of the female connector being fitted in the male connector. An insulated housing as the principal part of the female connector has compartments formed side by side to discretely accommodate therein socket contacts each lying on its side and secured on a wire end. A lance formed integral with each socket contact and facing sideways will be latched by a lug or detent formed in the compartment and protruding from an inner wall surface thereof. Another insulated housing also as the principal part of the male connector has further compartments that holds therein male contacts (viz., pin contacts) capable of fitting in the respective socket contacts and establishing an electrical connection therewith.

The lug formed in the prior art female connector is thus intended to latch the lance facing sideways, but the lug formed in the inner wall surface of said compartment of female connector can never be seen from the outside. Consequently, it is impossible to visually judge whether such a lance has surely or has not been latched by the lug. In the event that the lug had failed to firmly catch the lance, the socket contact would probably slip off the compartment.

In the high-voltage type connectors that have to ensure safety particularly when activated with a current, such an unintentional removal of any socket contact is not allowed at all. The female housing of each high-voltage type connector should hold the lance fixedly in position without failure.

### SUMMARY OF THE INVENTION

An object of the present invention made in view of the drawbacks inherent in the prior art connectors is to provide an electric connector such that the lance of each of socket contacts held in the compartments of a female housing can visually be checked to confirm its exact engagement with a lug or detent. This lug also formed in the female housing is intended to catch the lance so as to retain the socket contact, thereby ensuring an exact connection of a female connector with a male connector. The invention aims at an electric connector reliable in its performances, relatively compacted and nevertheless resistant to high voltages.

In order to achieve this object, an electric connector proposed herein may comprises a female connector of a depressed shape and a male connector having a cavity with a front opening for reception of the female connector being fitted in the male connector. An insulated housing as the principal part of the female connector has compartments formed side by side to discretely accommodate therein socket contacts each lying on its side and secured on a wire end. A lance formed integral with each socket contact and facing sideways will be latched by a lug or inner detent formed in the compartment and protruding from an inner wall surface thereof Another insulated housing also serving as the principal part of the male connector and having the cavity formed therein does have further compartments that holds therein male contacts capable of fitting in the respective socket contacts and establishing electrical connection therewith. Characteristically to the electric connector of the invention, it further comprises peep holes formed in at least one of upper and lower walls of the female housing, such that the lugs engaging with the respective lances are exposed to the outside within the peep holes. The male housing has to cover and hide these peep holes as a result of insertion of the female housing into the cavity of the male housing.

In a preferable example, the peep holes are formed in both the upper and lower walls of the female housing.

It is desirable that a latching mechanism is provided in the electric connector in order that the female and male connectors can be kept in a stable engagement with each other.

Preferably, the female housing may have a pair of lock arms that continue from elastic ears disposed at forward ends of opposite sides of this housing so as to protrude rearwards, and an outer detent may protrude sideways from a middle portion of each lock arm. Correspondingly, the male housing has pawls or shoulders formed in the inner wall surface of its cavity. Thus, as the female housing is pushed into the male housing, the forward portion of each lock arm will be forced into this cavity until its outer detent rides over the shoulder, snapping the lock arm into place.

Also preferably, a pair of guards may protrude from each of the opposite sides of female housing so that the lock arm is disposed in between such guards. These guards will come into contact with the fore face of the male housing, thereby assisting a worker or user to visually confirm neat engagement of female housing with the male housing.

### BRIEF DESCRIPTION OF THE DRAWINGS

FIG. 1 is a perspective view of a socket housing formed as the principal part of a female connector (viz., a socket connector) that is provided herein;

FIG. 2 is a plan view of the socket housing shown in FIG. 1;

FIG. 3 is a horizontal cross section of the socket housing;

FIG. 4 is a vertical cross section taken along the line 4-4 in FIG. 2;

FIG. 5 is a plan view of the female connector provided herein and shown in a finished state;

FIG. 6 is a horizontal cross section of the female connector shown in FIG. 5;

FIG. 7 is a front elevation of a male connector (viz., a base connector) that also is provided herein;

FIG. 8 is a horizontal cross section taken along the line 8-8 in FIG. 7;

FIG. 9 is a vertical cross section of the male connector shown in FIG. 7;

FIG. 10 is a perspective view of the female connector having fitted in the male connector; and

FIG. 11 is a horizontal cross section corresponding to FIG. 10 and showing the connectors having fitted one in another.

### THE PREFERRED EMBODIMENTS

Now some embodiments of the present invention will be described referring to the drawings.

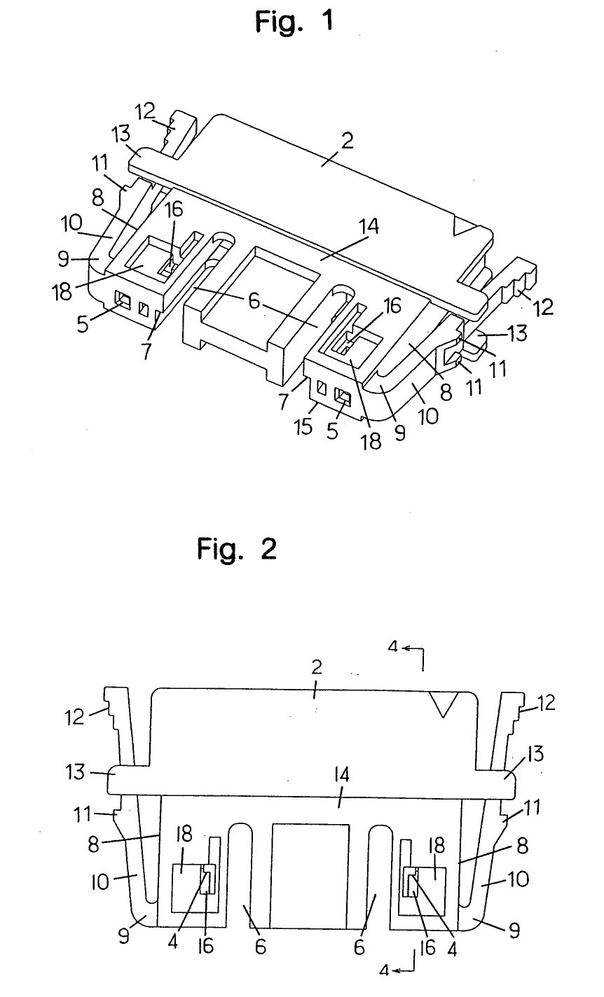

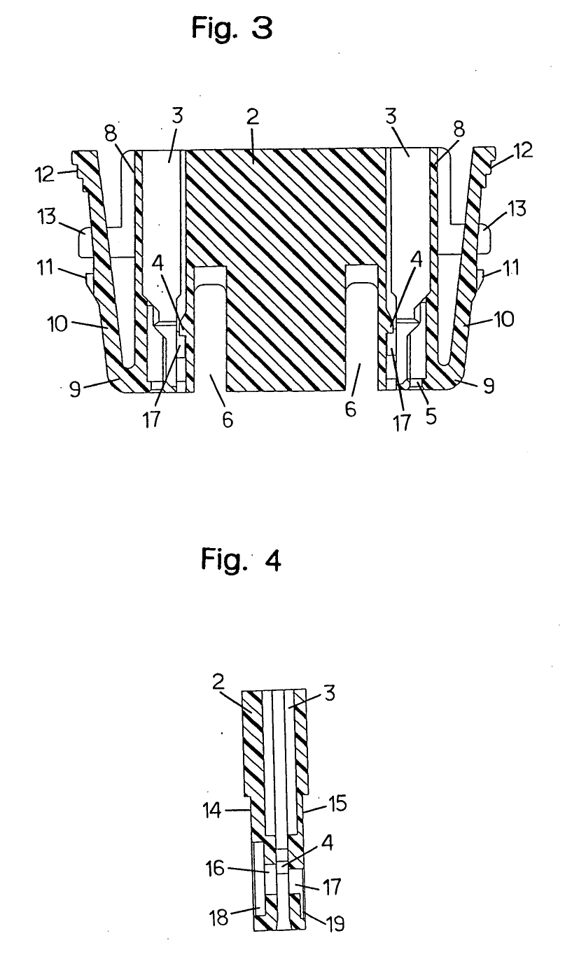

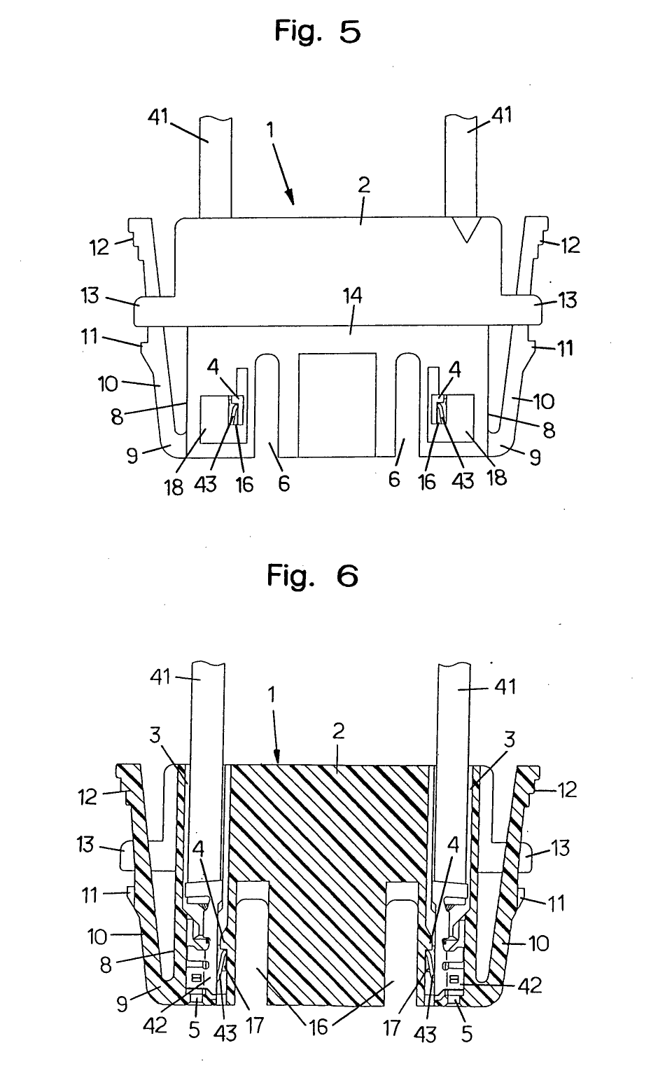

FIGS. 1 to 4 show a socket housing 2 as one of the principal parts of a socket connector 1 (as a female connector shown in FIGS. 5 and 6). The socket housing 2 is made of an insulating plastics to be generally of a parallelepiped shape depressed in contour and elongate sideways. Two compartments 3 are formed in parallel with each other and in opposite side regions of the socket housing 2, so that socket contacts 42 (see FIG. 6) crimped on wire ends 41 are secured in the respective compartments 3. Thus, the two compartments 3 are spaced a noticeable distance in order to afford sufficient spatial and linear distances between the socket contacts 42. An inner wall of each compartment has a lug or inner detent 4 protruding sideways therefrom to engage a lance 43 of the socket contact 42 so as to hold it in place. A front wall of each compartment 3 has a hole 5 formed therein, and one of pin contacts 28 held in a base connector 21 as the male connector in the invention will be inserted into this hole. Two cutouts 6 engraved in the socket housing 2 and located adjacent to the respective compartments 3 do extend from the front face to a middle portion of this housing. These cutouts 6 lie in a direction in which a mating base connector 21 will be urged to fit on the mating socket connector. A base housing 22 of the base connector 21 has partitions 25 formed integral therewith to fit in the respective cutouts 6. Each cutout 6 has at its middle height a stepped zone so that its lower region is widened, whereby said connectors 1 and 21 are inhibited from taking a reversed (viz., upside down) posture when engaging one another.

Elastic ears 9 continuing from fore corners of socket housing 2 do protrude outwards and sideways from the opposite sides 8 of this housing. A pair of lock arms 10 continue rearwards from the respective ears 9 so as to extend a full length from fore to rear and obliquely outwards. Each lock arm 10 is of a width smaller than the height (viz., thickness) of socket housing 2, and an outer detent 11 protruding outwards and sideways is formed in a middle portion of each lock arm. A rear portion extending from this middle portion of lock arm 10 serves as a push lever 12 useful to elastically and temporarily deform the lock arm inwardly. A pair of guards 13 protect opposite sides of each lock arm, at its portion located behind the outer detent 11 and intervening between the guards. Any foreign wire ends or the like will be prevented by these guards 13 from catching the lock arms 10, also enabling visual inspection and/or confirmation of engagement of this socket connector with the mating base connector 21.

Peep holes 16 and 17 are formed respectively in an upper wall 14 and lower wall 15 (see FIG. 4) in order to expose the lugs or inner detents 4 in these holes. Recesses 18 and 19 are formed the outermost layer of the upper and lower walls 14 and 15, in such a state as continuing to the respective peep holes 16 and 17. Each socket contact 42 crimped on the wire end 41 will be placed in the compartment so as to face sideways and lie on its side. The lance 43 of each socket contact will likewise face sideways to be latched by the lug or inner detent 4, and such an engagement of lance 43 with lug 4 can easily be confirmed visually through said peep holes 16 or 17. The peep holes need not necessarily be formed in both the upper and lower walls 14 and 15, but may be formed in either of them. The recesses 18 and 19 serves to reduce an amount of resin for molding the socket housing 2.

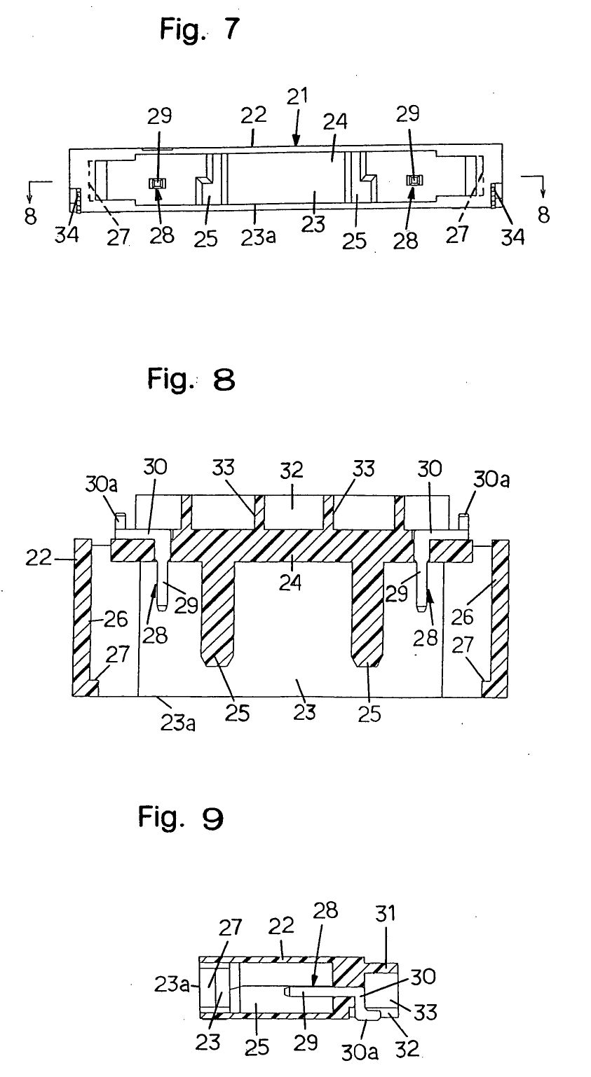

FIGS. 7 to 9 show the base connector 21 as the male connector in this invention. The base housing 22 of this connector 21 is of a depressed box-like shape having a front opening. A cavity 23 formed in base housing 22 is for insertion of the socket housing 2 of mating connector 1 and the fore portions of lock arms 10. Two partitions 25 formed integral with and protruding forwards from a rear wall 24 defining the cavity 23 are for insertion into the cutouts 6 of said mating connector 1. Inner wall surfaces 26 also defining the cavity 23 have fore ends formed integral with pawls or shoulders 27 for engagement with the outer detents 11 of lock arms 10. Pin contacts 28 penetrate the rear wall 24 so as to be fixed therethrough and outside the respective partitions 25. Contacting portions 29 of these pins 28 protrude forward towards the front opening 23a, within the cavity and along the housing's 22 center line, that lies in parallel the above-mentioned direction. On the other hand, lead portions 30 of those contacts 28 protrude rearwards from said wall 24 are bent at first sideways and outwards in opposite directions away from each other, and subsequently bent again to respectively assume an L-shaped solderable end 30a. Rear extensions 31 and 32 are projected from an upper and lower edges of the rear wall 24. Several webs 33 connecting these extensions one to another are intended to increase the linear and spatial distance by which the pin contacts' lead portions 30 are spaced one from another. Thus, the present connector assembly is improved in its resistance to high voltages that would cause some problems. In the drawings, the reference numeral 34 denotes reinforcement metals attached to the fore and outer surfaces of side walls of this base housing 22.

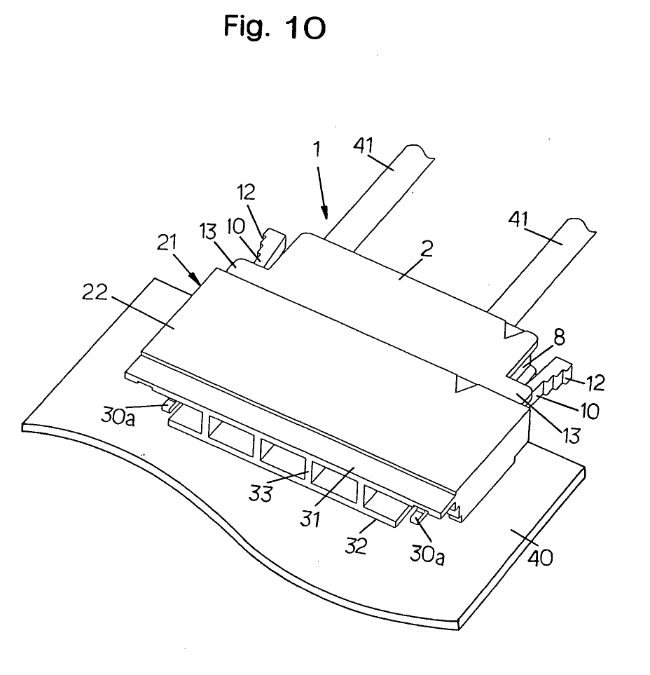

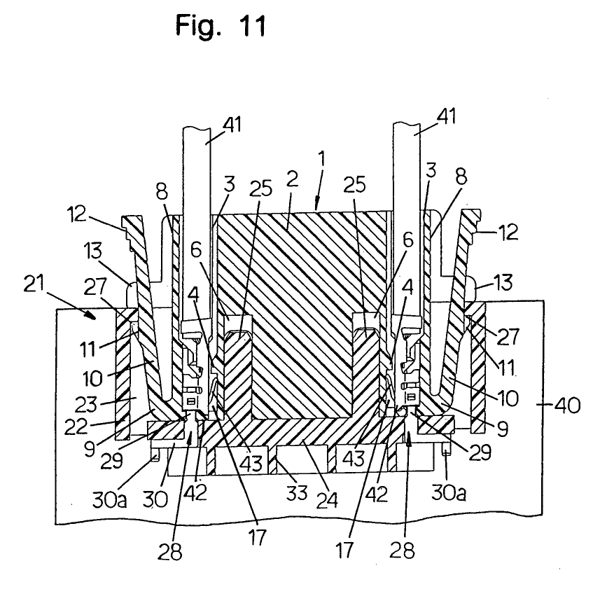

In operation, the socket connector 1 and base connector 21 described above will be made fit one in another as seen in FIGS. 10 and 11. In detail, and as discussed above, the socket connector 1 has the socket contacts 42 each crimped on the wire end 41 and placed in the compartment 3 of socket housing 2. Each socket contact 42 will be caused to face sideways when being placed in said compartment such that its lance 43 thus facing sideways will bear against the lug 4. This position of each lance 43 exactly caught by the lug 4 will visually be confirmed through the peep holes 16 and/or 17. On the other hand, the solderable end 30a of each pin contact 28 as well as both the reinforcement metals 34 are soldered to a printed circuit board 40 in the surface-mounting fashion.

The socket housing body 2 and the fore portions of lock arms 10 will be inserted into the cavity 23 through the front opening 23a of base housing 22. The cutouts 6 of socket housing 2 will thus fit on the partitions 25 of base housing so that the former housing is guided deep into the latter. Simultaneously and consequently with this process, the contacting portions 29 of pin contacts 28 enter the compartments 3 through the holes 3 so as to engage with and establish an electric connection with the respective socket contacts 42. Also consequently, the lock arms 10 will be inserted, causing themselves to make elastic inward deformation towards the opposite sides 8 of socket housing 2. As this housing 2 is further pushed together with its lock arms 10 into the base housing and towards a final position, the detents 11 of said arms will ride across the lateral edges of front opening 23a and advance deeply into the cavity 23. Then, the lock arms 10 will spring back to cause their detents 11 to come into a clicking engagement with the pawls 27 of base housing 22, thereby firmly fixing the socket housing 2 in the base housing. At the same time as these final motions of the parts noted above, the guards 13 of socket housing 2 collide with and bear against the front face of base housing 22. Such a contact of guards 13 with said face enables visual confirmation of correct ultimate position of those connectors 1 and 21. In this state of the members, the detents 11 of lock arms 10 are latched by the pawls 27 within the cavity 23 of base housing 22. By virtue of this feature, any external force will scarcely unlock those detents 11 off the pawls 27. In addition, the guards 13 will protect each arm 10 intervening between them from a possibility that any foreign article would unintentionally attack it.

When the socket connector 1 is to be released from the base connector 21, any user or operator may use his or her fingers to press the push levers 12 of lock arms 10 towards each other. The lock arms thus elastically deformed towards the opposite sides 8 will unlock the detents 11 from pawls 27, allowing the user or operator gripping the lock arms 10 to pull back them in order to remove the socket housing 2 out of the base housing 2.

The socket housing 2 of socket connector 1 reversed upside down might erroneously be forced a small distance into the base connector 21. In such an event, the stepped portions 7 in cutouts 6 will collide with the front faces of partitions 25. Thus, the socket housing 2 can never advance inwardly any longer, surely avoiding wrong connection of the complementary housings.

In summary, the electric connector of the invention is designed such that the lance of each socket contact facing sideways and held in the compartment of a female housing can visually be checked to confirm its exact engagement with a lug or inner detent formed in the inner wall surface of said compartment. Thus, any unintentional removal of any socket contact is avoided so that reliable and exact connection is ensured between the female and male connectors, rendering compacted the electric connector composed of these female and male connectors and enhancing its resistance to high voltages.

The latching mechanism for interlocking those connector housings is preferably built in them as defined in the accompanying claims 2 and 3. This structure will contribute to surer mutual connection of the male and female connectors.

1. An electric connector composed of a female connector and a male connector engageable therewith,
the female connector being of a depressed shape,
the male connector having a cavity with a front opening for reception of the female connector being fitted in the male connector,
an insulated housing as the principal part of the female connector having compartments formed side by side to discretely accommodate therein socket contacts each lying on its side and secured on a wire end,
a lance formed integral with each socket contact and facing sideways so as to be latched by a lug formed in the compartment and protruding from an inner wall surface thereof,
a further insulated housing also serving as the principal part of the male connector and having the cavity formed therein,
the further insulated housing further having compartments that hold therein male contacts capable of fitting in the respective socket contacts and establishing electrical connection therewith, and
peep holes formed in at least one of upper and lower walls of the female housing, such that the lugs engaging with the respective lances are exposed to the outside within the peep holes,
wherein the male housing is designed to cover and hide the peep holes as the female housing is inserted into the cavity of the male housing.

2. An electric connector as defined in claim 1, the peep holes are formed in both the upper and lower walls of the female housing.

3. An electric connector as defined in claim 1 or 2, further comprising a latching mechanism for keeping the connectors in a stable prising a latching mechanism for keeping the connectors in a stable engagement with each other, the mechanism being composed of an elastic lock arm that protrudes from each of opposite outer sides of the female housing, an outer detent protruding sideways from each lock arm, and pawls each formed in an inner side surface of the cavity in the male housing so that the detent and pawl catching one another do constitute the latching mechanism, when the female housing and the fore portion of each lock arm are received in the cavity.

4. An electric connector as defined in claim 3, further comprising a pair of guards may protrude from each of the opposite sides of female housing so that the lock arm is disposed in between such guards, wherein the guards will come into contact with the fore face of the male housing, thereby assisting a worker or user to visually confirm neat engagement of female housing with the male housing.
